(19) United States
(12) Patent Application Publication
(10) Pub. No.: US 2013/0244735 A1
(43) Pub. Date: Sep. 19, 2013

(54) Holder for a Mobile Telephone

(71) Applicant: BURY SP.Z.O.O., Mielec (PL)

(72) Inventor: Henryk BURY, Loehne (DE)

(73) Assignee: BURY SP.Z.O.O., Mielec (PL)

(21) Appl. No.: 13/798,306

(22) Filed: Mar. 13, 2013

(30) Foreign Application Priority Data
Mar. 13, 2012 (DE) 10 2012 005 559.5

(51) Int. Cl. H04M 1/02

(52) U.S. Cl. CPC H04M 1/0262
USPC 455/573

(57) ABSTRACT

A mobile telephone holder includes at least one charging coil that is movable between at least two different positions. When a mobile telephone is positioned within an accommodation device of the holder, the position of the charging coil in the accommodation device can be changed to make charging of the mobile telephone battery as efficient as possible. The mobile telephone holder allows for charging of telephones of different configurations and for orienting telephones in different orientations.

The invention refers to a holder for a mobile telephone that comprises at least one telephone charging coil, the holder comprising an accommodation device with a contact surface for accommodating the mobile telephone.

Holders of this sort are known from the prior art in a variety of forms. An accommodation device from an exemplary holder comprises a number of holding elements alongside the contact surface, which protrude above the contact surface. Should a mobile telephone be placed in the accommodation device, a form-fit or frictional interaction often occurs between these holding elements and the mobile telephone, guaranteeing a secure mounting of the mobile telephone. This is particularly important in motor vehicles, as the mobile telephone must be securely mounted also during a journey. In particular it must not be pulled out of the holder by possible shocks that may occur, for example, by driving through a pothole, or by other quickly occurring forces, such as those which arise due to sudden braking.

In order not to have to provide individual holders for various mobile telephones from possible different manufacturers, it is described in the prior art that these holding elements are to be arranged in such a way that they can be mutually moved, so that the distance of the holding elements can be adjusted to the length, width and/or height of the mobile telephone. In this way, it is possible to make universal holders for a variety of different mobile telephones.

Alongside varying measurements, mobile telephones also differ in the way that the battery available inside them can be charged. Conventionally, a plug connection is necessary for this, the length, diameter and possibly even the plug's angle of inclination differing from telephone to telephone. Nevertheless, in order to create a universal holder for as many different mobile telephones as possible, the possibility to charge a mobile phone that has been placed in the holder is often dispensed with in the prior art.

In the last few years, an increasing number of mobile telephones have come onto the market which can be charged without a cable and contact-free. With these mobile telephones intended for inductive charging, a telephone charging coil is found inside the appliance that interacts with charging coils in the charging device. The charging coil in the charging device is subjected to a current, creating a magnetic field in which the telephone charging coil of the mobile telephone is at least partially situated. In this way a current is induced in the telephone charging coil, which is used to charge the mobile telephone battery. The big advantage of this inductive charging of a mobile telephone is that an exact arrangement and positioning of the mobile telephone is no longer necessary, as is the case with a plug connection. It is sufficient if the telephone charging coil is at least partially situated in the magnetic field created by the current flowing through the charging coil of the charging device. However, to charge the telephone efficiently and economically, an exact a positioning as possible is nevertheless an advantage. However, should the telephone charging coil not be situated in the generated magnetic field, the telephone will not be charged. The area in which the mobile telephone must be arranged so it will be charged has been increased by using inductive charging, but careful positioning is still necessary.

Inductive charging appliances are known from the prior art which have more than one charging coil, for example five or seven coils. As a result, the area in which the mobile telephone can be placed and the battery still charged is greatly increased. However, there is the disadvantage that the production and component costs are considerably higher, due to the numerous charging coils in the charging device. In addition to this, a higher control input is necessary to determine the charging coils needed for optimal efficiency for any position of the telephone charging coil.

However, if only one charging coil is used, it is no longer guaranteed that charging will occur, should the mobile telephone be carelessly or inexactly positioned.

This is aggravated by the fact that the telephone charging coils in mobile telephones from various manufacturers are located in different positions inside the mobile telephone. An exact positioning of a charging coil in the charging device or the holder, which represents the optimal position for as many mobile telephones as possible, is therefore almost impossible to find.

Therefore, the invention aims to further develop a holder according to the preamble in such a way that as many different mobile telephones as possible can be optimally charged with as simple a charging circuit as possible.

The invention solves the problem at hand by means of a mobile telephone holder according to the preamble of claim 1 which is characterized by the fact that it has at least one charging coil and one positioning device which can be put in at least two different positions relative to the mobile telephone that is in the accommodation device. Therefore, the user who wishes to charge their mobile telephone in the holder by means of inductive charging can choose from two different positions of the charging coil in the holder, without changing the position and mounting alignment of the mobile telephone. This is particularly important when using a holder in a motor vehicle, as the alignment and positioning of the mobile telephone within the holder is often determined by the condition that the mobile telephone must be easy to access and to use for the driver of the vehicle.

It is advantageous that the positioning device may be a movement device, by means of which the at least one charging coil can be moved between the at least two different positions. For this, the charging coil is arranged in a purpose-made frame, which can be made from synthetic material, for example, and is connected to a movement control unit, so the person using the holder can, after placing the mobile telephone into the holder, change the position of the at least one charging coil in the holder accommodation device and thus make the charging of the mobile telephone battery as efficient as possible.

In a preferred embodiment of the invention, the at least one charging coil can be moved parallel to the contact surface of the accommodation device by the movement device.

This has the advantage that the distance between the charging coil in the holder and the mobile telephone is the same in every position of the charging coil and every setting of the movement device, in at least one direction perpendicular to the contact surface of the accommodation device. In addition, an arrangement of this sort is structurally easy to realize and integrate into the conventional structure of a corresponding holder.

In order to be able to determine and achieve the optimal position of the at least one charging coil for as many mobile telephones as possible to be placed in the holder, it is advantageous if the at least one charging coil can be moved in at least two different directions by the movement device. For example, these can be perpendicular to one another. In this way, the at least one charging coil can be moved on one plane, so that the number of possible positions is further increased. In order to achieve as great an effect as possible, it is advantageous if these planes run parallel to the contact surface of the accommodation device. Of course it is advantageous if the at least one charging coil is located as close as possible to the contact surface of the accommodation device. Should the plane, on which the at least one charging coil can be moved, be parallel to the contact surface of the accommodation device, this can be achieved across the whole movement area in which the at least one charging coil can be moved.

The charging coil can preferably be moved steplessly through the movement device. In this way, the optimal position of the at least one charging coil is adjustable along the possible paths of movement without the problem arising that the charging coil cannot be locked in the optimal position. The movement device, and therefore the charging coil, can preferably be locked in every possible position in order to prevent a delayed moving or sliding of the movement device and the charging coil attached to it, for example by means of a force during a journey in the vehicle. However, in comparison to a movement device which can only be put into a few predetermined shifting positions, the structural arrangement of an infinitely adjustable movement device is often more complicated.

In a particularly simple arrangement of a holder, the accommodation device is designed in such a way that a mobile telephone can be placed in the accommodation device in two different positions, which are set 180° to one another. The accommodation device can then be pivoted by 180°, together with the at least one charging coil. Here, the pivot axis does not run centrally through the at least one charging coil. In this case, the mobile telephone is thus useable in two different positions in the accommodation device. This results in two different positions of the at least one charging coil, relative to the telephone charging coil. Due to the fact that the accommodation device is designed in such a way that it can be pivoted 180°, the mobile telephone can still be secured in the desired position in the holder. This alignment is important for use in a motor vehicle, for example, as in this case, the mobile telephone must be easy to access and to use for the driver of the vehicle. The mobile telephone is thus useable in the holder in the desired position and in a position rotated by 180°, i.e. “upside down”. In this case the accommodation device can be pivoted with the at least one charging coil by 180°, so that the mobile telephone is returned to the desired position in the holder.

Alternatively to this, the at least one charging coil can also be arranged in a pivot device. This pivot device enables the charging coil to pivot about a pivot axis that does not run centrally through the at least one charging coil. In this way, when the at least one charging coil pivots in the pivot device, it implicates a change in the position of the charging coil relative to the mobile telephone that is in the accommodation device. Furthermore, in this way it is possible to achieve different positions of the at least one charging coil relative to the telephone charging coil.

It is advantageous that the accommodation device is designed so that it is adjustable, in order to be able to hold mobile telephones of varying dimensions. The accommodation device can preferably be adjusted to the length and/or width and/or thickness of the mobile telephone. In this way, it is possible to achieve a particularly secure hold of mobile telephones of various dimensions in the accommodation device.

The holder preferably comprises at least one first sensor for collecting sensor data, which act as a measurement of how efficiently the battery of a mobile telephone is charged when the mobile telephone is situated in the accommodation device. This can be the size of the current induced in the telephone charging coil, for example. It has been proven to be especially advantageous if the holder has a signalling device for emitting signals, depending on the sensor data collected by the at least one first sensor. From the signals sent out by the signalling device, the user who has placed a mobile telephone in the holder can, for example, recognize how well the at least one charging coil of the holder is positioned relative to the telephone charging coil. This is a measurement of how efficiently the battery inside the mobile telephone is charged.

In a preferred embodiment, the signalling device emits a repeating or flashing signal, for example. The efficiency of the charging or the quality of the positioning of the at least one charging coil relative to the telephone charging coil can be detected from the flashing frequency or the rate of repetition of the signal. Should a mobile telephone be placed in the accommodation device of the holder, for example, the signalling device emits a signal at a certain frequency. If the position of the at least one charging coil is now changed relative to the telephone charging coil, the repetition frequency of the signal also changes. The user can thus recognize if the new position of the at least one charging coil is preferable to the first position or not.

It is advantageous that the signalling device is designed to emit optical and/or acoustic signals. Alongside a repeating signal, such as flashing or the emission of repeating beeps, an LED display, for example, can also be provided, the number of lit LEDs acting as a measurement of the efficiency of the charging process, for example. Of course, another form of signalling is also possible.

Alternatively or additionally, with the aid of technical data about the mobile telephone, it can be determined where the telephone charging coil is arranged, prior to the use of the holder with a certain mobile telephone. It can also be determined which of the possible positions of the at least one charging coil is the optimal position for this particular mobile telephone. In this case the holder also works without a sensor and is still suitable for different mobile telephones, even those from different manufacturers.

In a preferred embodiment of the holder, the accommodation device can be put in a hold position and a release position, the accommodation device interlocking positively with the mobile telephone when in the hold position, and the mobile telephone being removable from the accommodation device when in the release position. For this, the holder comprises at least one second sensor through which it can be ascertained whether a mobile telephone is in the accommodation device, when the accommodation device is in the hold position. In order to achieve a form-fit connection between the accommodation device and a mobile phone situated inside it, it is known from the prior art to move existing holding elements away from each other so that the distance between them is greater than a corresponding dimension of the mobile telephone, such as the length. In this state, the release position, the mobile telephone can be put in the holder or the accommodation device, or removed from it. Should the mobile telephone be placed in it, the holding elements move towards each other, so that the distance between them decreases. The distance can now be optimally set to the dimension of the mobile telephone in such a way that it results in a form-fit connection and the mobile telephone cannot be removed when the holding elements are in this position, the hold position. The at least one charging coil of the holder is preferably only supplied with a current when the accommodation device is in the hold position. This ensures that the power consumption remains low and no additional energy costs occur due to a charging coil being supplied with a current, although the accommodation device is in the release position and therefore no form-fit connection with a mobile telephone can take place.

It can be determined via the at least one second sensor whether a mobile telephone is in the accommodation device when it is in the hold position. Of course it is also possible to put the accommodation device in the holding position without placing a mobile telephone inside it. However, without a mobile telephone it is not practical to supply the at least one charging coil of the holder with a current. This can be prevented by the second sensor. The sensor data collected by the second sensor can be used to interrupt the power supply to the at least one charging coil, for example, if the sensor data indicates that there is no mobile telephone located in the accommodation device.

It is advantageous that the holder is also equipped to emit a signal if there is no mobile telephone in the accommodation device when it is in the hold position. This can also be an optical and/or acoustic signal. This signal can also be emitted by the signalling device. In this way, the user can be prompted to put the accommodation device into the release position, resulting in, for example, an interruption in the power supply to the at least one charging coil.

Of course it is also possible to equip the holder described above with more than one charging coil, for example with two, three, five or seven charging coils.

In addition to this, the charging coil can also be moved automatically, for example. The measurements recorded by the at least one first sensor can be used to control this. For this, the position of the at least one charging coil is changed until the inductive charging is at its most effective.

A system according to the invention comprises a holder described above, as well as a mobile telephone which can be held in the accommodation device of the holder.

With the aid of a drawing an embodiment of the present invention will be explained in more detail. It shows

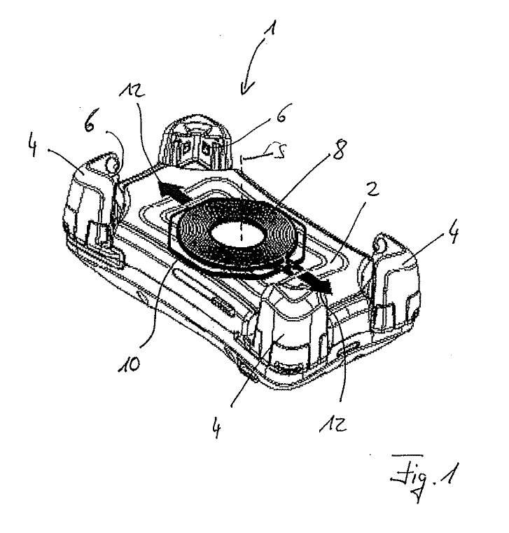

FIG. 1 the schematic depiction of a holder with the outline of a charging coil according to an embodiment of the present invention,

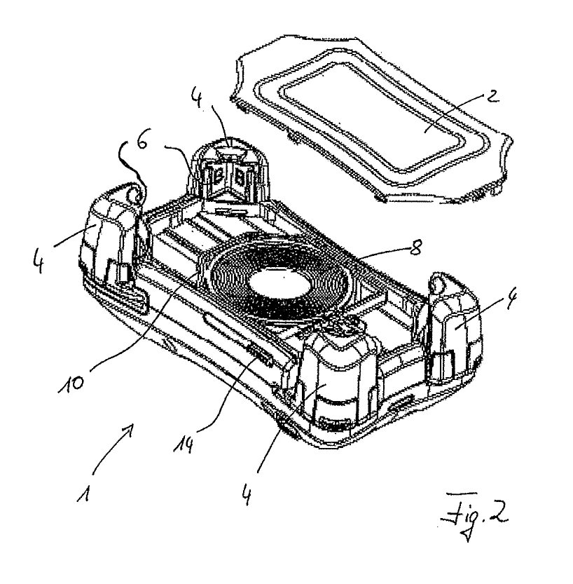

FIG. 2 the schematic three-dimensional depiction of a holder according to an embodiment of the present invention in a partially exploded view,

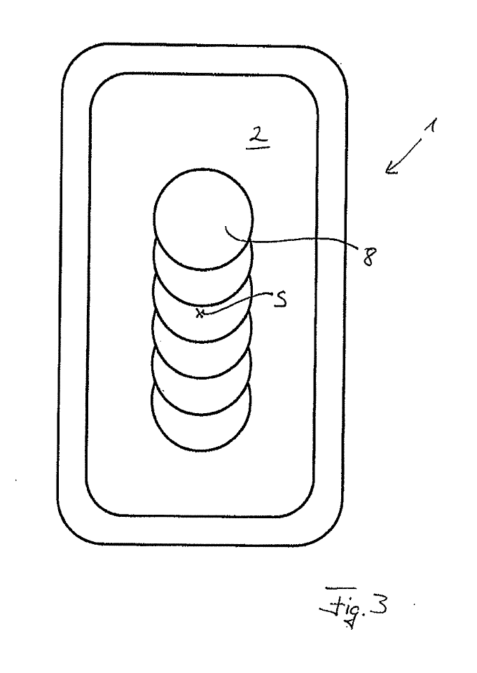

FIG. 3 the schematic depiction of various positions for a charging coil in a holder according to a further embodiment of the present invention,

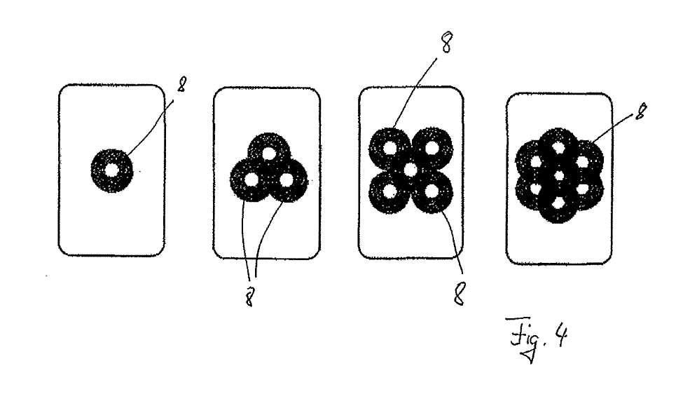

FIG. 4 the schematic depiction of various configurations with many different charging coils,

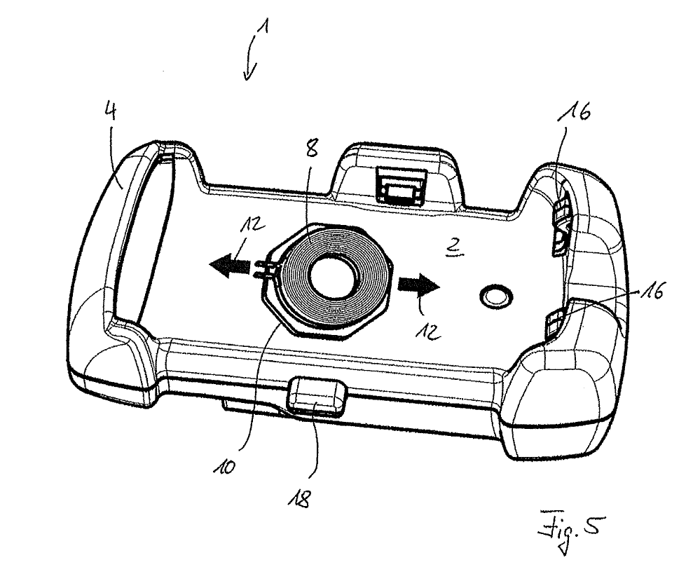

FIG. 5 the schematic depiction of a holder according to a further embodiment of the present invention,

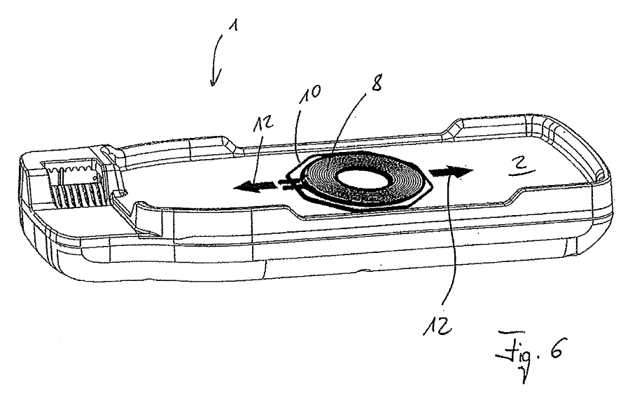

FIG. 6 the schematic depiction of a holder according to a further embodiment of the present invention,

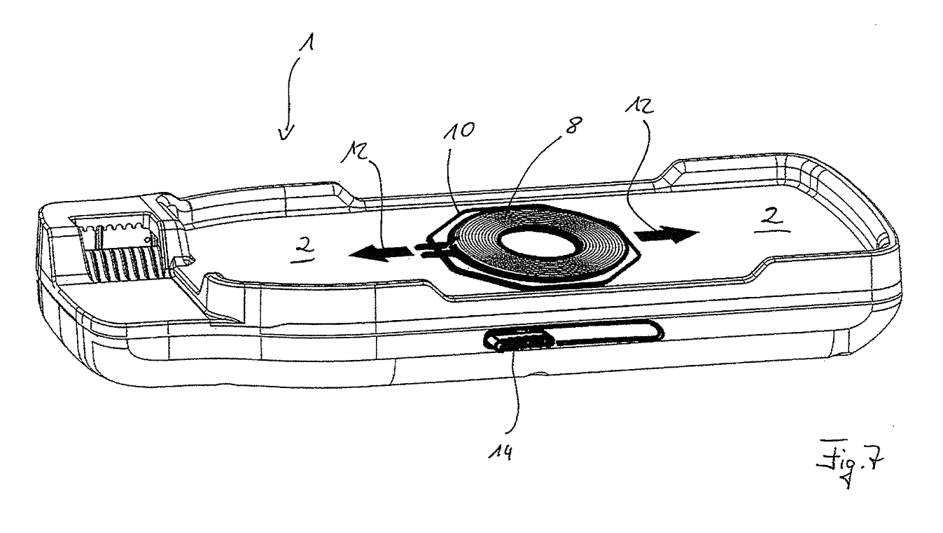

FIG. 7 the schematic depiction of a further holder according to a further embodiment of the present invention,

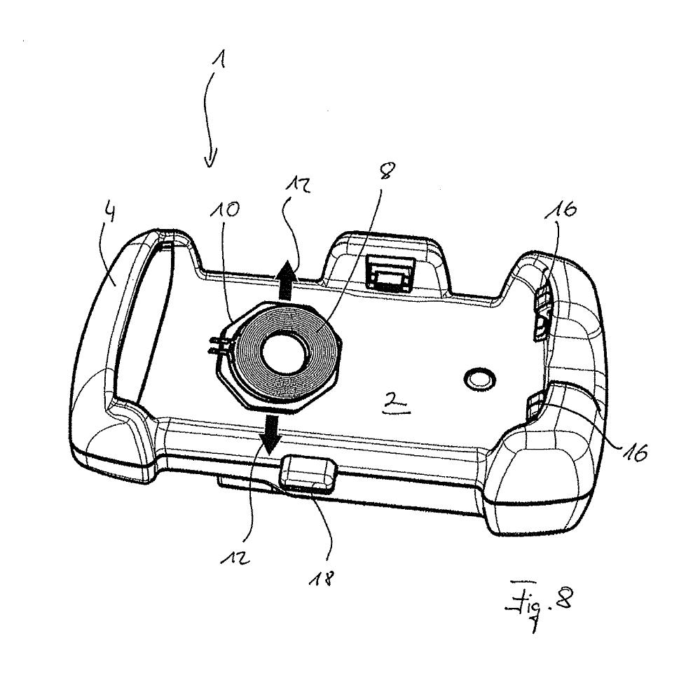

FIG. 8 the schematic depiction of a holder with a charging coil that can be moved horizontally,

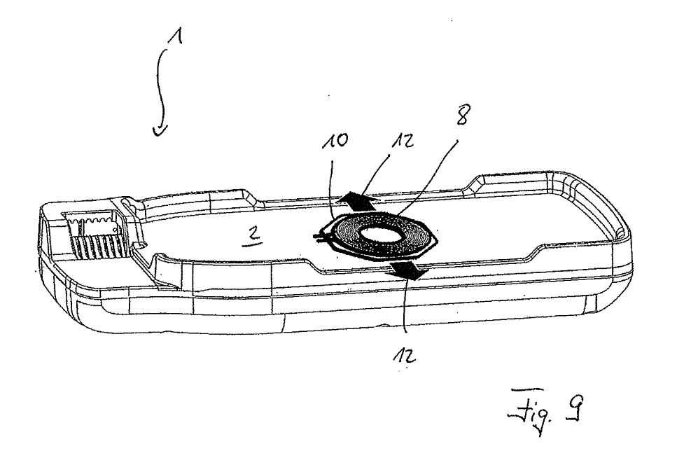

FIG. 9 a further schematic depiction of a holder according to an embodiment of the present invention, and

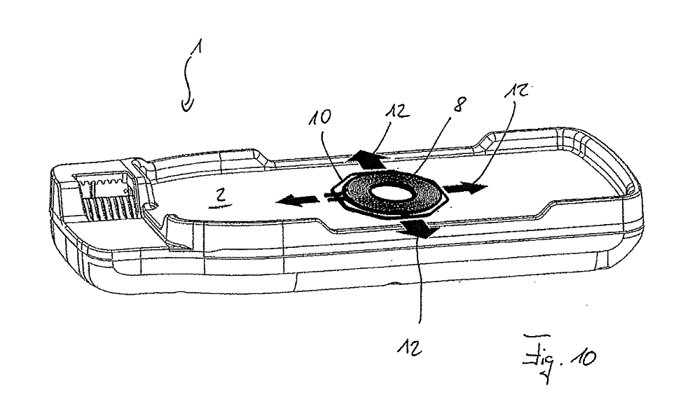

FIG. 10 a further schematic depiction of a holder according to an embodiment of the present invention.

FIG. 1 shows the schematic depiction of a holder 1 according to a first embodiment of the present invention. The holder 1 comprises an accommodation device which has a contact surface 2, as well as for holding elements 4, shown in the embodiment. The holding elements 4 each have an indentation 6 in which one corner of a mobile telephone, not depicted in FIG. 1, can be placed and locked. A charging coil 8 is schematically depicted which is, however, normally located underneath the contact surface 2, i.e. on the side that is facing away from the mobile telephone. The depiction in FIG. 1 only serves to improve clarity. The charging coil 8 is held in a frame 10 and can be moved along the two arrows 12. As a result, the position of the charging coil 8 relative to a mobile telephone located in the accommodation device is changeable.

In a special arrangement, the accommodation device of the contact surface 2 and the holding elements is mounted so that it can be rotated about a pivot axis S. However, as this embodiment shown in FIG. 1 runs centrally through the charging coil 8, a pivot about this axis S would not implicate a change in the relative position between the charging coil 8 and a telephone charging coil.

FIG. 2 shows the depiction from FIG. 1 in a partially exploded view. The contact surface 2 has been removed from the rest of the holder 1. The holder still comprises the four holding elements 4 with their indentations 6, which can lead to a form fit connection with the mobile telephone. The charging coil 8 is arranged in the frame 10, which is preferably made from a synthetic material so that it does not influence the magnetic field of the charging coil 8, which occurs as soon as a current runs through the coil.

It can be recognized that a valve 14 is arranged on the frame 10, which protrudes outwards from the holder 1. Using this, the position of the charging coil 8 can be shifted manually.

FIG. 3 shows a very schematic top view of the holder 1. The contact surface 2 is depicted, while the holding elements 4 have been removed for better clarity. The various positions of the charging coil 8 are depicted by overlapping circles. It can be recognized that the position in the embodiment shown can be moved across a relatively wide area of the contact surface 2, so that the optimal position of the charging coil 8 can be found, depending on the position of a telephone charging coil. Alternatively or additionally to this, it is possible to mount the accommodation device and, here in particular, the contact surface 2 and the holding elements 4 about the pivot axis S so that they can pivot. The position of the pivot axis is schematically indicated in FIG. 3. In this case, it is conceivable to considerably reduce the movability of the charging coil 8 and, for example, to only accept the lower four positions shown in the embodiment in FIG. 3 as possible positions. Should an accommodation device of this sort pivot about the pivot axis S by 180°, nothing changes with the positioning of the mobile telephone in the accommodation device, yet it enables new relative positions of the charging coil 8 with regards to the telephone charging coil.

Alternatively or additionally to this, it is also possible to move the accommodation device relative to the at least one charging coil 8. This is conceivable in the embodiment depicted in FIGS. 1 and 2 by, for example, moving the holding elements 4 relative to the charging coil. In this way, it is also possible to change the position of the charging coil 8 relative to the position of a telephone charging coil of a mobile telephone and thus achieve the desired effect according to the invention.

FIG. 4 shows the depiction of various configurations of charging coils 8. The depiction of a holder 1 to the far left has a charging coil 8 that it centrally arranged. In the second embodiment from the left, three charging coils are provided whose central points form the corners of a triangle. Next to that on the right is a schematic depiction of a holder 1 with five charging coils 8 and to the far right, a depiction with seven charging coils 8.

The more charging coils 8 that are used, the greater the chance one of these charging coils 8 has of achieving the optimal position relative to at least one telephone charging coil. However, the number of charging coils 8 leads to an increased control input, in order to determine the configuration required for the optimal efficiency of the inductive charging of the charging coils 8 subjected to a current.

An optimal positioning of the charging coil 8 relative to the telephone charging coil exists when both coils are arranged concentric to one another. The can be indicated by an acoustic or optimal signal, for example. This can be different colours or number of LEDs, varying flashing frequencies, various types of acoustic signals, such as rising or fading volumes, frequencies or repetition rates of the tones.

As an example, an acoustic signal will be described in more detail. The optimal position of the at least one charging coil 8 relative to the telephone charging coil, in which the maximum charging current is thus achieved, is signalled by means of a continuous signal tone lasting for four seconds, for example. A similar system is known from parking assistance systems in cars, for example, whose signal tone repetition rate increases the nearer you come to an obstacle.

However, should the charging coil be in a position that is only almost optimal, this can be indicated by a very quick repetition of a signal tone. If the charging coil 8 is subsequently moved, the repetition rate of this tone changes, so the person using the holder 1 recognizes if they have moved the at least one charging coil 8 in the right direction. The lower the tone repetition frequency and the greater the pauses between the individual signal tones, the further away the at least one charging coil 8 is from the optimal position.

The described acoustic signals are preferably only emitted when the accommodation device is in the hold position and, for example, it has been determined by a second sensor that a mobile telephone is in the accommodation device. Should the holder be in the release position, for example, in which no mobile telephone can be placed with a form-fit connection, this can be detected, for example, by the large distance between the existing holding elements. Alternatively or additionally to this, a release button can be provided by means of which the accommodation device can be put in the release position. The operation of this release button or the fact that it has been moved into the release position can be detected. The charging equipment is inactive in this position, so that the at least one charging coil 8 is not subjected to a current.

However, should the holder 1 be in the hold position, which can be detected, for example, by a release button that has been moved into this position, the charging equipment becomes active, so that the at least one charging coil is subjected to a current. With this sort of holder arrangement, the user can save energy and power if they leave the accommodation device in the release position, as long as there is no mobile telephone in the holder.

For times when the accommodation device is in the hold position with no mobile telephone in it, the person using the holder is informed of this via a further acoustic signal. Alternatively or additionally to this, the power supply to the charging device or the at least one charging coil 8 can also be interrupted.

A further signal, different to the first signals that have so far been described, is intended for times when the mobile telephone battery is completely charged. Alternatively or additionally to this separate signal, the power supply to the charging coil 8 can be automatically interrupted by the holding device.

FIG. 5 shows a further holder 1, where the charging coil 8 is arranged so that it can be moved in one direction. The charging coil 8 can normally not be recognized in the holder 1 that is depicted, as it is located underneath the contact surface 2. The holder 1 shown in FIG. 5 has a holding element 4 into which the mobile telephone can be placed. The mobile telephone is subsequently pushed in the direction of the contact surface 2. The holder 1 has snap elements 16 that are moved by the pressing down of the mobile telephone and, as soon as the mobile telephone is in the right position, snap forward again. This creates a form-fit locking between the snap elements 16 and the holding element 4 on one side, and the mobile telephone on the other side.

The charging coil 8 shown in FIG. 5 can be moved, with the frame in which it is located, along the longitudinal direction of the holder 1. This is depicted by the two arrows 12. The holder 1 also has a release button 18 by means of which the mobile telephone can be released from the form-fit locking, when it should be removed from the holder 1.

FIG. 6 shows a further embodiment of the holder 1, where the charging coil 8 can again be moved with the frame 10 along the arrows 12. With the embodiment of the holder 1 depicted in FIG. 6, a mobile telephone is placed onto the contact surface 2. Holding elements that would provide a form-fit locking between the accommodation device and the mobile telephone placed in it are not depicted in FIG. 6.

FIG. 7 shows the holder 1 from FIG. 6, which now has a valve 14 through which the frame 10 can be moved along the arrows 12 with the charging coil 8 located on it. In this way, a convenient shifting of the at least one charging coil 8 is also possible, if a mobile telephone is lying on the contact surface 2.

FIG. 8 shows the holder 1 from FIG. 5, whereby the charging coil 8 can now be moved with the frame 10 in the transverse direction along the depicted arrow 12.

FIG. 9 shows the holder 1 from FIG. 6, again with the difference that the charging coil 8 can be moved with the frame 10 in the transverse direction, which is again depicted by the arrow 12.

FIG. 10 shows the same holder 1, whereby the charging coil 8 can now be moved with the frame 10 in the longitudinal direction, as well as the transverse direction. This is symbolized by the depiction of four arrows 12. In this way, it is possible to move the charging coil 8 into the optimal position for many different mobile telephone, since a movement within the plane that spans the two movement directions is possible.

### REFERENCE NUMERALS

1 Holder
2 Contact surface
4 Holding element
6 Indentation
8 Charging coil
10 Frame
12 Arrow
14 Valve
16 Snap element
18 Release button

S Pivot axis

1. A holder for a mobile telephone that includes at least one telephone charging coil, the holder comprising an accommodation device with a contact surface for accommodating the mobile telephone, wherein the holder has at least one charging coil and a positioning device, the at least one charging coil being able to be put in at least two different positions by the positioning device relative to the mobile telephone that is in the accommodation device.

2. The holder according to claim 1, wherein the positioning device is a movement device, by means of which the at least one charging coil can be moved into at least two different positions along a plane.

3. The holder according to claim 2, wherein the at least one charging coil can be moved along a plane in at least two different directions by the movement device.

4. The holder according to claim 2, characterized by the fact that the at least one charging coil can be moved steplessly by the movement device.

5. The holder according to one claim 1, wherein the accommodation device is designed so that it is adjustable, in order to be able to hold mobile telephones of varying dimensions.

6. The holder according to claim 1, wherein the holder comprises at least one first sensor for collecting sensor data, which act as a measurement of how efficiently the battery of a mobile telephone is charged when the mobile telephone is situated in the accommodation device.

7. The holder according to claim 6, wherein the holder has a signaling device for emitting signals, depending on the sensor data collected by the at least one first sensor.

8. The holder according to one claim 1, wherein the holder can be put in a hold position and a release position, the accommodation device interlocking positively with the mobile telephone when in the hold position, and the mobile telephone being removable from the accommodation device when in the release position, wherein the holder includes at least one second sensor through which it can be ascertained whether a mobile telephone is in the accommodation device, when the accommodation device is in the hold position.

9. The holder according to claim 8, wherein the holder is equipped to emit a signal if there is no mobile telephone in the accommodation device when it is in the hold position.

10. A system with a holder according to claim 1 and a mobile telephone which can be placed in the accommodation unit of the holder.
